(19) United States
(12) Patent Application Publication
(10) Pub. No.: US 2023/0302612 A1
(43) Pub. Date: Sep. 28, 2023

(54) Wrench Sound Seat Lubrication Structure

(71) Applicant: KABO Tool Company, Taichung City (TW)

(72) Inventor: Chih-Ching Hsieh, Taichung City (TW)

(21) Appl. No.: 18/187,245

(22) Filed: Mar. 21, 2023

(30) Foreign Application Priority Data
Mar. 23, 2022 (TW) 111110909

(51) Int. Cl. B25B 23/142; F16N 1/00; F16N 7/02

(52) U.S. Cl. CPC B25B 23/1427; F16N 1/00; F16N 7/02; B25B 13/463

(57) ABSTRACT

A wrench sound seat lubrication structure includes: a seat member having an oil receiving space formed at a hollow internal thereof, a top end of the seat member having an opening formed thereon; one or a plurality of through holes formed to penetrate through a side wall of the seat member and fluidly connected to the oil receiving space; an actuating member pivotally attached to the opening on the top end of the seat member. The user is able to store a lubricant oil inside the oil accommodating space in advance. During use, the lubricant oil is slowly released from the through holes and the top opening, allowing the outer side of the seat member to be lubricated for a long period of time, thereby prolonging its useful lifetime.

### BACKGROUND OF THE INVENTION

### 1. Technical Field

The present invention relates to a wrench, and in particular, to a wrench sound seat lubrication structure capable of providing excellent lubricating effect.

### 2. Description of Related Art

Mechanical torque wrench is formed by mechanical parts, including: a hollow tubular member and a plurality of mechanical parts installed inside and outside the tubular member. Since friction occurs among mechanical parts, resistance is generated such that the precision of the torque wrench can be affected, and wear of mechanical parts is increased. Accordingly, manufacturers in the industry are seeking solutions to reduce the frictional resistance among component parts of a mechanical torque wrench in order to maintain the precision of its torque value.

Sound seat is one of the component parts of a mechanical torque wrench, and it is installed inside the tubular member and elastically abutted by a compression spring. When the elasticity of the compression spring abutting the sound seat is changed, the torque value setting of the torque wrench can be adjusted. During the operation process of the torque wrench, the sound seat slides inside the tubular member of the wrench to generate friction with the inner wall of the tubular member. Although known art has provided a solution to overcome the friction of the sound seat, it still fails to achieve proper effect and further improvement is necessary. To improve the friction of the wrench sound seat lubrication structure, the inventor seeks to provide an optimal solution of the present invention after years of research and effort.

### BRIEF SUMMARY OF THE INVENTION

An objective of the present invention is to provide a wrench sound seat lubrication structure. An lubricant oil is stored inside a seat member first, which is then released slowly to increase the lubricating effect between the sound seat and the tubular member inner wall of the torque wrench, thereby reducing the friction therebetween and increasing its useful lifetime.

The present invention provides a wrench sound seat lubrication structure, comprising:
a seat member having an oil accommodating space formed at a hollow internal thereof, a top end of the seat member having an opening formed thereon;
one or a plurality of through holes formed to penetrate through a side wall of the seat member and fluidly connected to the oil accommodating space;
an actuating member pivotally attached to the opening on the top end of the seat member.

Accordingly, the lubricant oil can be stored inside the oil accommodating space in advance, which can then be released via the opening and the through holes slowly, in order to achieve the lubricating effect on the outer peripheral surface of the seat member and the actuating member for a relatively longer period of time, allowing long period of lubrication during its actuation inside the wrench and reducing the frictional resistance. As a result, the torque value of the wrench can be maintained at a certain precision for a long period of time.

### BRIEF DESCRIPTION OF THE SEVERAL VIEWS OF THE DRAWINGS

To further illustrate the objectives, technical features and technical effects of the present invention, three preferred embodiments of the present invention are explained in the following along with the accompanied drawings:

FIG. 1 is a cross sectional view of the sound seat installed on a torque wrench according to a preferred embodiment of the present invention;

FIG. 2 is a perspective view of the sound seat according to the first preferred embodiment of the present invention; FIG. 3 is an exploded perspective view of FIG. 2;

FIG. 4 is a longitudinal cross sectional view of FIG. 2;

FIG. 5 is a partially enlarged view of FIG. 1, illustrating the state of the sound seat of the present invention installed inside a torque wrench;

FIG. 6 is a perspective view of the sound seat according to the second preferred embodiment of the present invention;

FIG. 7 is a perspective view of the sound seat according to the third preferred embodiment of the present invention; and

FIG. 8 is a cross sectional view of the sound seat according to the fourth preferred embodiment of the present invention and being installed on a torque wrench.

### DETAILED DESCRIPTION OF THE INVENTION

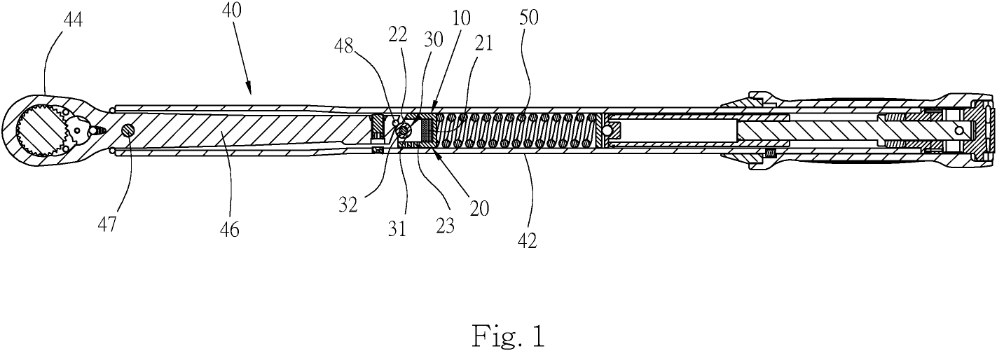

T Please refer to FIG. 1. The present invention provides a wrench sound seat lubrication structure 10, installed inside a tubular member 42 of a torque wrench 40. When the force applied on the wrench to rotate a screw (bolt or nut) reaches the setting of the torque value, the sound seat 10 generates a sound to achieve the warning effect.

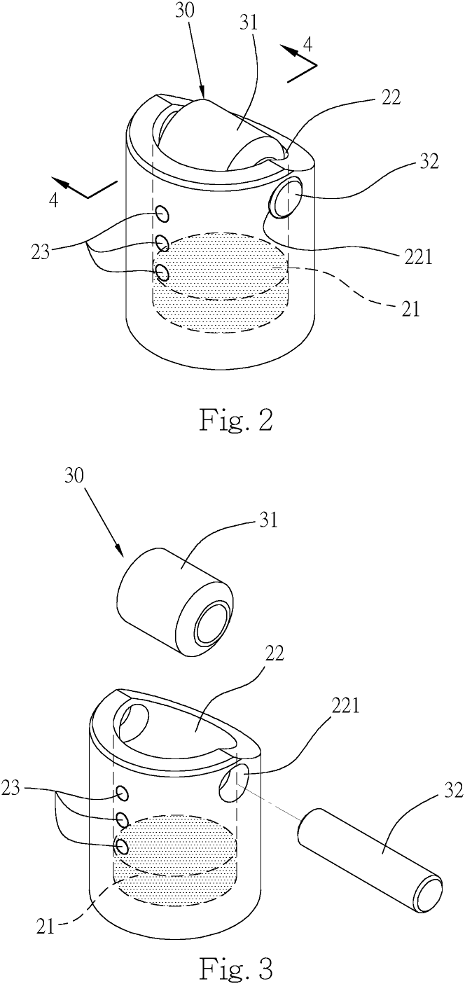

Please refer to FIG. 2 and FIG. 3, showing a sound seat 10 according to a first preferred embodiment of the present invention, comprising: a seat member 20 and an actuating member 30.

The seat member 20 is made of a metal material. The seat member 20 includes an oil accommodating space 21 formed to indent inward, and the top end of the seat member includes an opening 22 formed thereon. The opening 22 further includes two attachment slots 221 arranged at the lateral side. In addition, the side edges of the seat member 20 includes three through holes 23 penetrating therethrough and arranged spaced apart from each other at an equal distance along the axial direction. The through holes 23 are fluidly connected to the oil accommodating space 21.

The actuating member 30 is a roller 31 and uses a pivotal axle 32 for pivotally attached to the attachment slot 221 of the opening 22, and a portion of its volume also protrudes out of the seat member 20 to be partially positioned inside the oil accommodating space 21, allowing the roller 31 to form the actuating member. The actuating member 30 is not limited to the roller described in this preferred embodiment, and it can be other structural type.

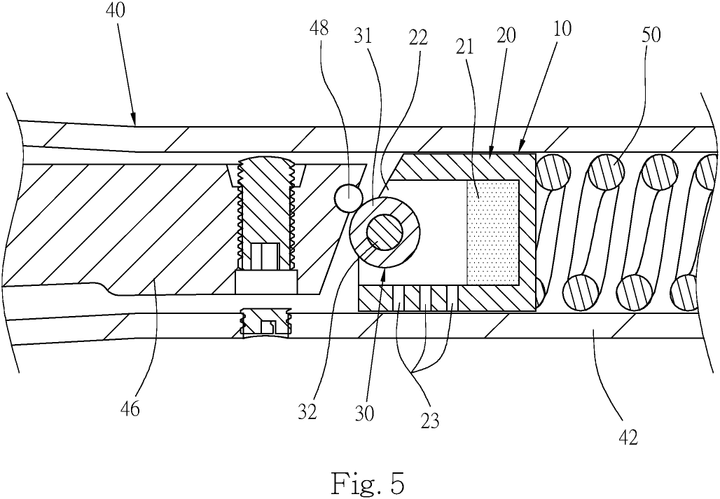

Please refer to FIG. 1 and FIG. 5. The sound seat 10 of the present invention is installed inside a tubular member 42 of a mechanical torque wrench 40, and it is able to slide inside the tubular member 42. The wrench 40 includes a working head 44 for holding and rotating a screw member (bolt or nut) or a socket. The working head 44 is secured at the front end of a working shaft 46. The working shaft 46 uses a pivotal axle 47 for pivotally attaching to the front end of the tubular member 42, in order to swing with the pivotal axle 47 as the supporting point. The rear end of the working shaft 46 is located inside the tubular member 42. A small column 48 is installed at the rear end of the working shaft 46, and a portion of its volume protrudes out of the working shaft 46.

The sound seat 10 is located at the rear of the working shaft 46, and another end thereof is elastically abutted by a compression spring 50, allowing the roller 31 and the small column 48 to be elastically contacted with each other. The actuating end 20 of the sound seat 10 and the rear end of the working shaft 46 form a trip mechanism. When the force applied to rotate the wrench 40 exceeds the setting of the torque value, the small column 48 at the rear end of the working shaft 46 generates an disengagement action with the roller 31 on the sound seat 10. Such disengagement effect causes the working shaft 46 to collide with the tubular member 42 and to generate vibration and sound, in order to achieve warning effect for the operator. Accordingly, the operator is informed that the torque of the wrench has reached the setting of the torque and operation needs to be stopped.

The sound seat 10 is abutted by the compression spring 50 and during the process of the disengagement action, it slides inside the tubular member 42. To allow the sound seat 10 to slid smoothly, the oil accommodating space 21 inside the seat member 20 of the sound seat 10 flows out from the through holes 23 and the opening 22 continuously, allowing the area between the outer peripheral surface of the seat member 20 and the inner wall of the tubular member 42 as well as the roller 31 of the actuating member 30 to be lubricated by the lubricant oil released from the oil accommodating space 21, thereby reducing the frictional resistance at the surrounding of the sound seat 10.

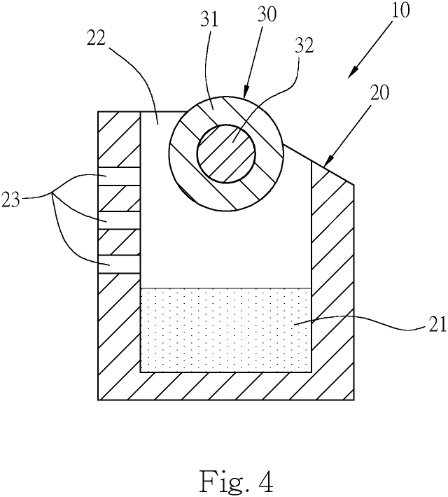

The present invention allows the oil accommodating space 21 inside the seat member 20 of the sound seat 10 to accommodate a lubricant oil therein, such that the lubricant oil inside the oil accommodating space 21 to lubricate the attachment area between the sound seat 10 and the inner wall of the tubular member 42 for a long period of time. Next, please refer to FIG. 4. Each oil accommodating space 21 provided in this embodiment is installed inside the seat member 20, and a larger accommodating space is provided to accommodate an appropriate amount of lubricant oil. In addition, the lubricant oil is attached to and stored inside the oil accommodating space 21 to prevent loss thereof.

Accordingly, the oil accommodating space 21 of the seat member 20 of the sound seat 10 is able to slowly release lubricant oil for a long period of time, allowing the area between the sound seat 10 and the inner wall of the tubular member 42 to receive long-term and sufficient lubrication, thereby maintaining the lubrication between the sound seat 10 and the tubular member 42. Accordingly, the frictional resistance of the sound seat can be reduced for a long period of time, and the precision of the torque value of the torque wrench 40 can be maintained for a long period of time, and its useful lifetime can be prolonged.

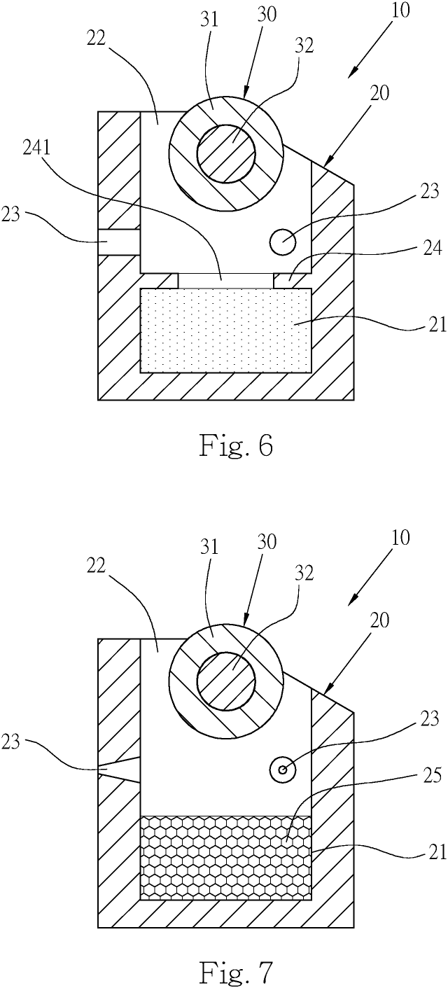

FIG. 6 shows a second preferred embodiment of the sound seat of the present invention. The same components use the same sign numbers as the first preferred embodiment, and details thereof are omitted. For the second preferred embodiment:

The seat member 20 includes a protruding rib 24 formed therein. The protruding rib 24 can be integrally formed or separately installed, such as the formation method of a C-shape latch. The center of the protruding rib 24 includes a cut-out portion 241, and an area of cut-out portion 241 is smaller than the area of the opening 22. The protruding rib 24 is arranged between the oil accommodating space 21 and the opening 22. With the cut-out portion 241, the flow velocity of lubricant oil inside the oil accommodating space 21 can be reduced, allowing the lubricant oil inside the oil accommodating space 21 to be used continuously for a longer period of time. Furthermore, the through holes 23 are arranged between the protruding rib 24 and the opening 22. The through holes 23 are also arranged on one identical circumferential surface and spaced apart from each other at equal distance, allowing the lubricant oil to be released from the peripheral surface of the seat member 20, in order to achieve uniform lubrication between the sound seat 10 and the tubular member 42.

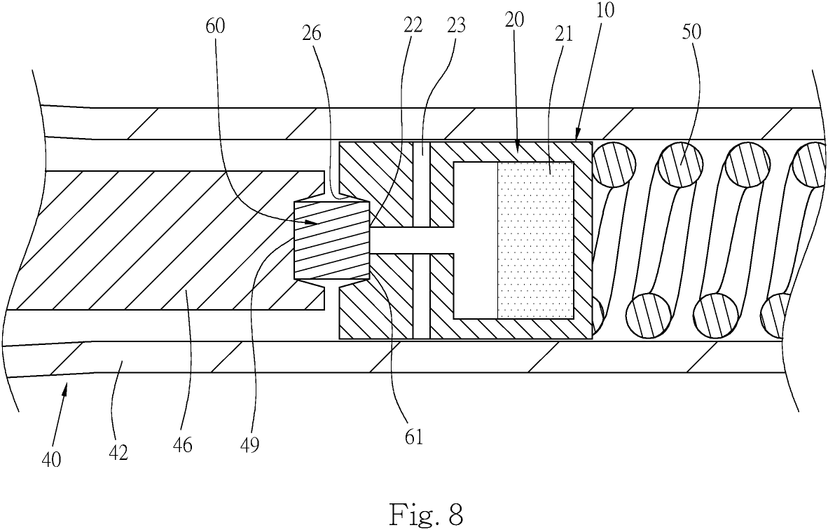

FIG. 7 shows a third preferred embodiment of the sound seat of the present invention. The same components use the same sign numbers as the first preferred embodiment, and details thereof are omitted. For the third preferred embodiment:

To store greater amount of lubricant oil and to prevent fast loss of lubricant oil inside the oil accommodating space 21, the oil accommodating space 21 includes an oil storage piece 25. The oil storage piece 25 can be a sponge or foam or other substance capable of absorbing lubricant oil, such that it is able to absorb greater amount of lubricant oil and to also release lubricant oil slowly, in order to prevent overly fast flow of the lubricant oil that may reduce its time of use. Furthermore, to reduce the outflow rate of the lubricant oil, the through holes 23 are arranged to be tapered holes. The hole diameter of each one of the through holes 23 decreases from the inner side of the seat member 20 toward the outer side, thereby reducing the size of the outlet.

FIG. 8 shows a fourth preferred embodiment of the sound seat of the present invention. The same components use the same sign numbers as the first preferred embodiment, and details thereof are omitted. For the fourth preferred embodiment:

The top surface of the seat member 20 of the sound seat 10 includes a receiving slot 26 formed to indent inward thereon. The top end of the receiving slot 26 is an open end, and the bottom portion of the receiving slot 26 includes the opening 22. The bottom portion of the working shaft 46 of the torque wrench 40 includes an upper receiving slot 49 correspondingly formed to indent inward. An actuating member 60 is received between the receiving slot 26 and the upper receiving slot 49, the actuating member 60 is a block 61, and the block 61 is a hexahedron block. The surface of the block 61 contacting with the receiving slot 26 is greater than the surface of the opening 22, such that the block 61 is prevented from inserting into the opening 22. The block 61 is pressed between the receiving slot 26 and the upper receiving slot 49, and the block 61 can be lubricated by the lubricant oil inside the oil accommodating space 21, allowing the block 61 to achieve the lubricating effect.

Although the aforementioned embodiments are used to describe the present invention, such embodiments are provided for illustrative purpose only such that they shall not be used to limit the scope of the present invention. Any structural designs equivalent to the present invention shall be considered to be within the scope of the claims of the present invention. The sound seat of the present invention is a novel structure in this technical field and is also of inventive step. Accordingly, an application is hereby submitted according to the law..

What is claimed is:

1. A wrench sound seat lubrication structure, comprising:
a seat member having an oil accommodating space formed at a hollow internal thereof, a top end of the seat member having an opening formed thereon;
one or a plurality of through holes formed to penetrate through a side wall of the seat member and fluidly connected to the oil accommodating space;
an actuating member arranged at the opening on the top end of the seat member;
thereby storing a lubricant oil inside the oil accommodating space and releasing the lubricant oil via the opening and the through holes.

2. The wrench sound seat lubrication structure according to claim 1, wherein the through holes are arranged along an axial direction of the seat member.

3. The wrench sound seat lubrication structure according to claim 1, wherein the through holes are arranged along one identical circumferential surface of the seat member.

4. The wrench sound seat lubrication structure according to claim 1, wherein the actuating member is a roller, two ends of the roller include a pivotal axle respectively, and the opening of the seat member includes two attachment slots formed thereon and provided for the two pivotal axles to be pivotally attached thereto.

5. The wrench sound seat lubrication structure according to claim 1, wherein the actuating member is a block, the block is arranged on the top end of the seat member and at a top end of the opening, and an area of the opening is smaller than the actuating member.

6. The wrench sound seat lubrication structure according to claim 1, wherein a top surface of the seat member includes a receiving slot formed to indent inward thereon, the actuating member is received inside the receiving slot, and the opening is arranged at a bottom portion of the receiving slot.

7. The wrench sound seat lubrication structure according to claim 1, wherein each one of the through holes is a tapered hole, and an hole diameter decreases from one side of the oil accommodating space toward an outer side of the seat member.

8. The wrench sound seat lubrication structure according to claim 1, further comprising an oil storage piece, and the oil storage piece arranged inside the oil accommodating space.

9. The wrench sound seat lubrication structure according to claim 1, further comprising a protruding rib arranged inside the seat member and positioned between the actuating member and the oil accommodating space, a middle area of the protruding rib having a cut-out portion, and an area of the cut-out portion being smaller than an area of the opening of the seat member.

10. The wrench sound seat lubrication structure according to claim 9, wherein the through holes are positioned between the protruding rib and the opening of the seat member.
